(19) United States
(12) Patent Application Publication
(10) Pub. No.: US 2002/0087362 A1
(43) Pub. Date: Jul. 4, 2002

(54) Systems and methods for tracking administration of medical products

(76) Inventors: David M. Cobb, Bethlehem, PA (US); Stephen W. Pettit, Suwanee, GA (US)

Correspondence Address: LYON & LYON LLP, 633 WEST FIFTH STREET, SUITE 4700, LOS ANGELES, CA, 90071, US

(21) Appl. No.: 09/845,046

(22) Filed: Apr. 26, 2001

Related U.S. Application Data
(63) Continuation-in-part of application No. 09/753,910, filed on Jan. 2, 2001.

(51) Int. Cl. G06F 17/60

(52) U.S. Cl. 705/3

(57) ABSTRACT

A system for tracking medical products administered to individuals includes a container having a medical product therein and a communications device, such as a microchip, attached to the container that includes product data identifying the medical product. The container is provided to a medical provider, who uploads the product data from the communications device into a tracking file on the provider's computer. The medical product is administered to an individual, and individual data related to the individual, such as demographic data and administration date, are included in the tracking file. The tracking file is transmitted to a remote host computer that adds the tracking file to a medical product database. Preferably, the data transmitted to the host computer excludes personal information capable of identifying the individual patient, thereby providing a method for tracking medical products delivered to individuals, while maintaining anonymity of the individuals.

This application is a continuation-in-part of application Ser. No. 09/753,910, filed Jan. 2, 2001, the disclosure of which is expressly incorporated herein by reference.

### FIELD OF THE INVENTION

The present invention relates generally to systems and methods for tracking medical events, and more particularly to systems and methods for tracking the delivery of pharmaceuticals, immunizations, or other medical products to individuals using machine-readable data devices.

### BACKGROUND OF THE INVENTION

Immunization tracking is an area of high public interest. Current methods vary considerably from area to area, creating difficulties in maintaining accurate records. This is particularly a problem with infants and school-aged children, especially when they are moved between localities or schools. Immunization records may not be available and/or may not be compatible with those used at the new location. Maintaining records and tracking immunizations by locality, age groups, and/or the entire population may be difficult, if not impossible, with current methods.

Another problem with current methods is identifying and providing effective corrective action to adverse immunization reactions and/or defective immunization products. Although methods are in place to attempt to identify adverse reactions, there is no satisfactory method to ensure all individuals at risk are identified and notified. The lack of good documentation and tracking reduces the effectiveness of methods of identifying adverse reactions to medical products.

U.S. Pat. No. 5,865,470 discloses a peel-off coupon and card used to track the immunization record for a child. The card has a series of coupons having bar codes that represent the required vaccination shots needed by a child. The card may be presented to a doctor at the time of vaccination. The doctor may remove the peel-off coupon and place it on a tracking sheet for tracking purposes. U.S. Pat. No. 5,673,944 discloses a business form for use at record receiving locations. The record ply of the form includes immunization data for tracking purposes.

Accordingly, convenient and reliable systems and methods for tracking delivery or administration of pharmaceuticals, immunizations, or other medical products would be considered useful.

### SUMMARY OF THE INVENTION

The present invention is directed to systems and methods for tracking medical events, and more particularly to systems and methods for reviewing, monitoring, or tracking the delivery of pharmaceuticals, immunizations, or other medical products to individuals using machine-readable data devices.

In accordance with one aspect of the present invention, a system is provided that includes a container including a medical product therein and a read/write communications device attached to the container. The read/write device includes product data including at least one of product identification data, manufacturer identification data, lot number data, and product expiration date data associated with the medical product. A reader is also provided for obtaining the product data from read/write communications device.

In a preferred embodiment, the container is an injection device, such as a syringe, a vial, and the like. Alternatively, the container may be product packaging including one or more individual vials or syringes therein. Preferably, the communications device is incapable of being separated from the medical product before administration thereof to an individual patient. In another preferred embodiment, the read/write communications device is a microchip attached to the container. Preferably, the microchip includes non-volatile memory storing the product data. In addition, the system may include a provider computer coupled to the reader. The provider computer may include memory for storing the product data obtained by the reader, and an interface for entering individual data related to a patient receiving the medical product, the computer configured for combining the product data and individual data into a tracking file. The system may also include a host computer at a location remote from the provider computer, the host computer and provider computer configured for communicating with one another via an electronic network, such as the Internet. The host computer may include a medical product database, the host computer configured for including at least a portion of tracking files from a plurality of provider computers in the medical product database.

In accordance with another aspect of the present invention, a medical tracking method is provided that includes attaching a machine-readable communications device, such as a bar code sticker, magnetic strip, or microprocessor chip, to a medical product, e.g., to its container, delivery device, or packaging at the time of manufacture and before shipping from the manufacturer's location. The machine-readable communications devices include encoded product data including product identification, lot or batch number, product expiration date, dosage, adverse reaction warnings, and/or other data, as appropriate.

Health care providers, such as hospitals, clinics, or individual doctors, may use readers compatible with the communications devices to upload the product data stored on the communications device into the memory of a computer located at the provider's location, preferable at or near the time of administration. At the time of administration, additional patient-related data, including patient identification data, administration date and time, administered dose, and/or demographic data, may be entered into the provider's computer to create an individual tracking file. In a preferred embodiment, the provider's computer is connectable to a network, such as a tracking network including other provider computers and a host computer operated by one or more central tracking authorities. In other embodiments, product manufacturer's computers may also be connectable to the network.

The centralized tracking network allows the central tracking authority to track product administration by geographical area, age, sex, race, and/or other demographic categories. The central tracking authority may also track adverse-reactions to medical products and/or defective products. The central tracking authority may notify providers, product manufacturers, and/or at-risk groups, individuals e.g., directly or through providers, depending on security firewalls provided by the network.

In other embodiments, the tracking method provides personal medical-tracking “smart cards” that may be carried by individuals. The personal medical-tracking cards may include personal immunization data or other medical administration data that may be uploaded, and/or updated by a healthcare provider at the time of administration of a pharmaceutical, immunization, or other medical product.

### BRIEF DESCRIPTION OF THE DRAWINGS

These and other features, aspects and advantages of the present invention will become better understood with regard to the following description, appended claims and accompanying drawings where:

FIG. 1 is a block diagram illustrating a method for immunization tracking, in accordance with the present invention, and an immunization-tracking network for sharing immunization-tracking files;

FIG. 2 is a block diagram of the immunization-tracking network of FIG. 1 showing security features of the network and personal immunization cards that interface with the immunization provider computers;

FIG. 3A is a perspective drawing of a syringe with an attached bar-code sticker for use with an immunization-tracking method of the present invention;

FIG. 3B is a perspective drawing of a syringe with an attached magnetic strip for use with an immunization-tracking method of the present invention;

FIG. 3C is a perspective drawing of a medical bottle with an attached bar-code sticker for use with an immunization-tracking method of the present invention; and

FIG. 3D is a perspective drawing of an immunization vial with an attached magnetic strip for use with an immunization-tracking method of the present invention.

### DESCRIPTION OF THE PREFERRED EMBODIMENTS

The following is a description of preferred embodiments of systems and methods for tracking administration of medical products, such as immunizations or other pharmaceuticals, using machine-readable devices associated with medical products, such as on their containers, delivery devices, or packaging.

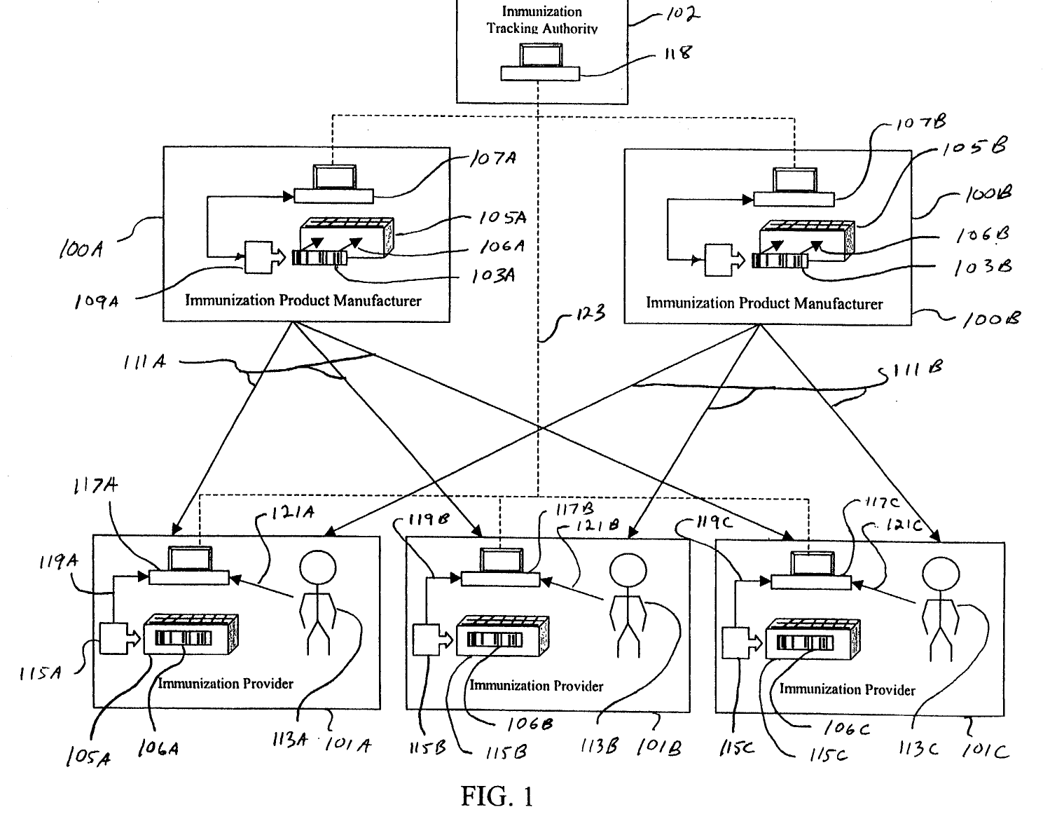

FIG. 1 is a block diagram of a preferred embodiment of an immunization-tracking network including immunization product manufacturers 101A, 101B, immunization providers 101A, 101B, 101C, and immunization-tracking authority 102. For simplicity, the following system and method descriptions are written for immunization product manufacturer 100A, and immunization provider 101A, although the system, e.g., hardware and software, and methodology applies to the other manufacturers and providers in a similar manner.

A machine-readable communications device 103A, such as a bar code sticker, may be attached to an immunization product, e.g., the immunization product packaging 105A at step 106A at immunization product manufacturer location 10A. The immunization product packaging 105A may be packaging for individual immunization-containing products or components, such as vials or syringes, or the immunization product packaging may be cartons, boxes or connected strips of immunization-containing components. Preferably, the communications device is attached to the product such that the device may not be separated from the product before administration to a patient, e.g., by attaching the device to an individual dosage container or a delivery system, such as a syringe, syringe safety system, or other injection device. More preferably, a read/write machine-readable communications device is used, such as a magnetic strip, a “smart” chip including a microprocessor, and the like.

In a preferred embodiment, the product data encoded onto the communications device 103A includes: product identification, such as generic or chemical name of the product; manufacturer identification; product lot number; and/or product expiration date. In addition or alternatively, the communications device may have sufficient non-volatile memory such that the immunization product data encoded on the device also includes product manufacturing date, dose size, administration requirements and instructions, and/or product warnings, such as possible allergic responses.

Preferably, a manufacturer's computer 107A or other electronic device may be used to input or download the immunization product data to the communications device. For example, an upload/download device, e.g., an electronic reader/writer, may be used initially to download product data to a microchip or a magnetic strip, and/or to read and supplement or replace the product data. Alternatively, if a bar code sticker 103A is used, a bar code sticker printer may be used to generate an initial bar code sticker 103A, and/or to read an existing bar code sticker and print a new one with new or supplemented data. The manufacturer's computer 107A may maintain a file in its memory of all or part of the immunization product data encoded on the bar code sticker 103A.

The immunization product, e.g., packaging 105A, including the machine-readable barcode sticker 103A may be shipped to immunization provider 101A in step 111A for immunizing one or more individuals 113A. After receipt and, preferable at the time of immunization or administration, the immunization product data on bar code sticker 103A of immunization product packaging 105A is read or uploaded, e.g., by bar code reader 115A, to the provider's computer 117A in step 119A.

Individual immunization data on the individual 113A receiving the immunization or other medical product may also be entered into the provider's computer 117A in step 121A at approximately the time of administration. The individual immunization data may include at least one data entry relating to the individual being immunized. In a preferred embodiment, the information includes demographic data related to the individual 113A, such as age, sex, race, geographic location, and the like. In addition or alternatively, the individual immunization data may include information traceable to the specific individual and may include the individual's name, social security number, medical insurance number, and/or other data traceable to the individual. In a preferred embodiment, the individual immunization data also includes the time and date of administration, and/or additional medical, insurance, or other information useful in tracking and/or analyzing immunizations.

The combination of immunization product data uploaded to provider's computer 117A in step 119A and individual immunization data entered or uploaded in step 121 A provides the data necessary for a provider immunization-tracking file maintained on provider's computer 117A. In a preferred embodiment, the provider immunization-tracking file on provider's computer 117A is accessible to the network host computer 118 of immunization-tracking authority 102 by immunization-tracking network 123. In alternative embodiments, the immunization-tracking files on immunization provider computers 117B, 117C may also be connected directly to the host computer 118 of the immunization-tracking authority 102. In addition, manufacturer's immunization product files on manufacturer's computers 107A, 107B may also be accessible to immunization-tracking authority 102 via network 123.

The ability of immunization-tracking authority 102 to access at least portions of provider immunization-tracking files and, optionally, manufacturer's immunization product tracking files via the network 123 allows the network host computer 118 to implement immunization tracking. For example, the network host may periodically query the provider immunization-tracking files to obtain demographic data substantially anonymously, e.g., determine the total number of immunized individuals for a given immunization product and/or the number of immunized individuals from traceable groups based upon geographic residence, age, race, and/or other desired groupings. Preferably, the provider computer 117A limits access of the host computer 118 to protect the privacy of individual patients associated with the tracking files. Alternatively, the provider computer 118 may periodically, e.g., automatically or upon being instructed, upload all or a portion of its tracking file data to the host computer 118. In a further alternative, all of the tracking file data including personal patient information may be provided to the host computer 118.

A tracking method in accordance with the present invention may also allow tracking of immunization problems, such as allergic reactions by querying the provider immunization-tracking files. The method also allows tracking individuals receiving defective immunization products by identifying individuals receiving defective immunization products and/or lot numbers identified by manufacturers. At-risk individuals may be identified and contacted directly by the tracking authority, although preferably the tracking authority may contact the immunization provider if individual personal data is maintained within the provider immunization tracking file for personal security reasons.

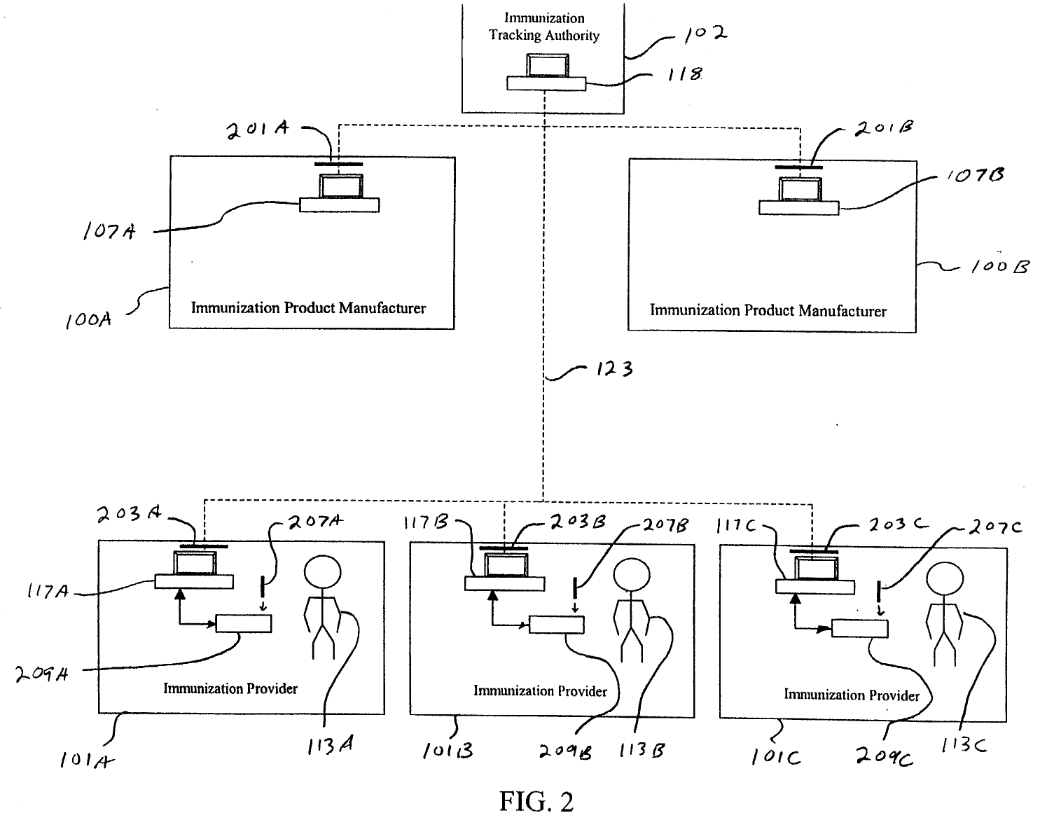

FIG. 2 is a block diagram of immunization-tracking network 123 showing operational and security features of a preferred embodiment of the present invention. Firewalls 201A, 201B at the immunization product manufacturers 100A and 100B and firewalls 203A, 203B, 203C at immunization providers 101A, 101B and 101C provide security by preventing unauthorized access to immunization-tracking files or other information residing on the respective computers. The firewalls may be physical hardware or password-protected software that restricts data flow to those authorized by the immunization-tracking authority or, alternatively, the respective resident user.

For example, the firewalls may be configured so that the immunization-tracking authority may upload immunization-tracking files from the respective immunization providers through firewalls 203A, 203B and 203C, but the immunization providers may not have access through the firewalls to immunization-tracking files residing with other immunization providers. Alternatively, firewalls 201A and 201B may allow only specific portions of the tracking files including no personal identification information into manufacturers computers 107A, 107B.

Another embodiment of the present invention provides personal immunization records maintained on personal immunization cards 207A, 207B, 207C. These cards may be dedicated “smart cards” containing a microprocessor for storing the personal immunization records of individual patients, or they may be an immunization tracking record portion kept on personal medical record smart cards known in the art. In preferred embodiments, the personal immunization records maintained on the cards may include the medical product data described above, e.g., immunization product identification, lot number, and/or date administered of all immunizations administered to the individual 113A, 113B, 113C. Additional or all of the immunization data of the provider immunization tracking file discussed previously may be downloaded onto personal immunization cards 207A, 207B, 207C.

Personal immunization card reader/writers 209A, 209B, 209C may upload the personal immunization record for the individual when the individual arrives at the immunization provider's facility for verification of the current immunization status of the individual. After immunization, an updated immunization record may be downloaded onto the individual's personal immunization card 207A by the respective reader/writer. In a preferred embodiment, reading and/or writing to the personal immunization cards may require entering a personal identification number (PIN) of the individual to provide personal security.

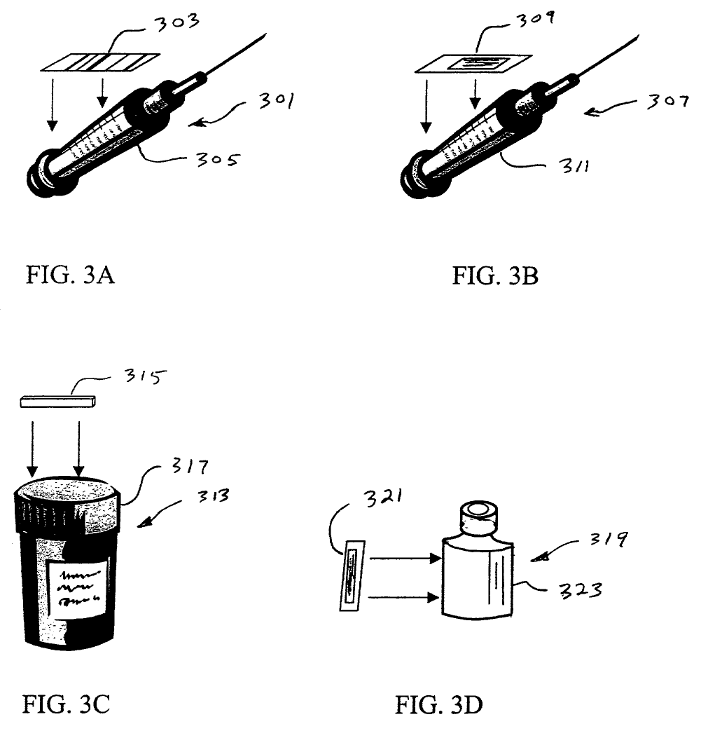

FIG. 3A is a perspective drawing of a syringe 301 used for immunization having a machine-readable bar-code sticker 303 placed on the body 305 of syringe 301. Bar-code sticker 303 may be attached by an adhesive, such as a pressure sensitive adhesive, hot melts, cold melts, or adhesive strips.

FIG. 3B is a perspective drawing of a syringe 307 used for immunization having a machine-readable magnetic strip 309 placed on the body 311 of syringe 307. Magnetic strip 309 may be attached by an adhesive ,such as a pressure sensitive adhesive, hot melts, cold melts, or adhesive strips.

FIG. 3C is a perspective drawing of a bottle 313 used for immunization having a machine-readable microchip 315 attached on the cap 317 of bottle 313. Microchip 315 may be attached by an adhesive, such as a pressure sensitive adhesive, hot melts, cold melts, or adhesive strips.

FIG. 3D is a perspective drawing of a vial 319 used for immunization having a machine-readable magnetic strip 321 attached to body 323 of vial 319. Magnetic strip 321 may be attached by an adhesive, such as a pressure sensitive adhesive, hot melts, cold melts, or adhesive strips.

Accordingly, the reader will see that the systems for immunization-tracking in accordance with the present invention may provide a flexible and reliable method for tracking immunizations from a number of immunization providers. The system may provide the following additional advantages: accurate tracking of immunized groups by immunization product and demographic data, such as age groups, and geographical areas; accurate tracking of adverse-reactions to immunization products; identifying at-risk individuals of immunizations; providing feedback to immunization product manufacturers; providing immunization-tracking files to a network operable by a immunization-tracking authority, and/or providing security for personal information and data.

Although the description above contains many specifications, these should not be construed as limiting the scope of the invention but merely providing illustrations of some of the presently preferred embodiments of this invention. For example, the systems and methods may be used as input to patients' medical files, billing files, and/or insurance files. Thus, the scope of the invention should be determined by the appended claims and their legal equivalents, rather than by the examples given.

What is claimed is:

1. A system for acquiring data related to a medical product being administered to a patient, comprising:
an injection device comprising a medical product therein;
a microchip attached to the injection device, the microchip comprising non-volatile memory storing product data including at least one of product identification data, manufacturer identification data, lot number data, and product expiration date data associated with the medical product; and
a reader for obtaining the product data from the microchip.

2. The system of claim 1, wherein the injection device comprises a syringe, and wherein the microchip is attached to a barrel of the syringe.

3. The system of claim 1, further comprising a provider computer coupled to the reader, the provider computer comprising memory for storing the product data obtained by the reader, and an interface for entering individual data related to a patient receiving the medical product, the computer configured for combining the product data and individual data into a tracking file.

4. The system of claim 3, further comprising a host computer at a location remote from the provider computer, the host computer and provider computer configured for communicating with one another via an electronic network.

5. The system of claim 4, wherein the host computer comprises a medical product database, the host computer configured for including at least a portion of the tracking file in the medical product database.

6. The system of claim 5, wherein the provider computer is configured for periodically transmitting at least a portion of individual data and associated medical product data in tracking files in the memory of the provider computer to the host computer.

7. The system of claim 6, wherein the individual data transmitted by the provider computer excludes personal information capable of identifying respective patients.

8. The system of claim 6, wherein the individual data comprises demographic data of patients received respective medical products.

9. The system of claim 6, wherein the provider computer is configured for transmitting the at least a portion of the individual data and associated medical product data upon being queried by the host computer.

10. The system of claim 1, further comprising a manufacturer computer configured for downloading product data to the microchip.

11. A system for acquiring data related to a medical product being administered to a patient, comprising:
a container comprising a medical product therein;
a read/write communications device attached to the container, the read/write device comprising product data including at least one of product identification data, manufacturer identification data, lot number data, and product expiration date data associated with the medical product; and
a reader for obtaining the product data from read/write communications device.

12. The system of claim 11, wherein the read-write communications device comprises microchip comprising non-volatile memory storing the product data.

13. The system of claim 11, further comprising a writer for transferring the product data to the read/write communications device.

14. The system of claim 11, wherein the container comprises a unit dose container comprising a dosage of the medical product for administration to only one individual.

15. A method for acquiring data related to a medical product being administered to a patient, the method comprising:
attaching a communications device to product packaging for the medical product, the communications device comprising non-volatile memory;
downloading product data to the communications device, the product data comprising at least one of product identification data, manufacturer identification data, lot number data, and product expiration date data;
shipping the medical product for delivery to a provider; and
receiving individual data related to individual patients receiving the medical product, the individual data originating from the provider.

16. The method of claim 15, wherein the individual data comprises demographic data associated with respective individual patients.

17. The method of claim 15, wherein the individual data excludes personal information capable of identifying respective individual patients.

18. The method of claim 15, wherein the product packaging comprises at least one of a container comprising the medical product therein, and an injection device comprising the medical product therein.

19. The method of claim 15, further comprising uploading the product data at a provider's location; and administering the medical product to an individual.

20. The method of claim 15, further comprising entering individual data related to the individual into a tracking file, and including at least a portion of the product data in the tracking file.

21. A method for acquiring data related to a medical product being administered to a patient, comprising:
providing a container comprising a medical product therein, and comprising a communications device storing product data, the product data comprising at least one of product identification data, manufacturer identification data, lot number data, and product expiration date data associated with the medical product;
uploading the product data into a tracking file on a provider computer;
administering the medical product to an individual patient;
including demographic data associated with the individual patient in the tracking file; and
transmitting the product data and the demographic data in the tracking file to a location remote from the provider computer.

22. The method of claim 21, wherein the tracking file excludes personal information capable of identifying the individual patient.

23. The method of claim 21, wherein the transmitting step comprises excluding personal information capable of identifying the individual patient included in the tracking file from the remote location.

24. The method of claim 21, wherein the product data and demographic data are transmitted to a host computer for inclusion in a medical product database.

25. The method of claim 21, wherein the container comprises an injection device for injecting the medical product into an individual.

26. The method of claim 25, wherein the administering step comprises injecting the medical product into the individual.

27. The method of claim 21, wherein the container and communications device are configured such that the communications device is incapable of being separated from the medical product before administration thereof to an individual patient.

28. The method of claim 21, wherein the demographic data comprises at least one of age data, sex data, race data, and geographic location data associated with the individual patient.

29. A method for tracking administration of a medical product to an individual using a machine-readable communications device, the method comprising:
providing a read/write communications device on a medical product package, the read/write communications device storing product data, the product data comprising at least one of product identification, manufacturer identification, product lot number, manufacturing date, and dosage;
uploading the product data from the read/write communications device to a computerized tracking file at a medical provider location;
entering patient data and administration date data to the tracking file generally at the time of administration of the medical product to an individual; and
transmitting the tracking file to a host computer at a location remote from the medical provider location in a manner that excludes personal information capable of identifying the individual from being accessed by unauthorized persons.

30. The method of claim 29, wherein the tracking file further comprises an administered dose entered generally at a time of administration of the medical product to the individual at the medical provider location.

31. The method of claim 29, wherein the read/write communications device comprises a magnetic strip attached to the product package.

32. The method of claim 29, wherein the read/write communications device comprises a microprocessor attached to the product package.

33. The method of claim 29, wherein the product package is a vial.

34. The method of claim 29, wherein the product package is a package comprising a plurality of vials.

35. The method of claim 29, wherein the product package is a syringe.
